(19) United States
(12) Patent Application Publication
(10) Pub. No.: US 2002/0036172 A1
(43) Pub. Date: Mar. 28, 2002

(54) Process and apparatus for the removal of heavy metals, particularly arsenic, from water

(76) Inventor: Giovanni Del Signore, Firenze (IT)

Correspondence Address: GIOVANNI DEL SIGNORE, VIA SAN MATTEO IN ARCETRI 25, FIRENZE, 50125, IT

(21) Appl. No.: 09/682,715

(22) Filed: Oct. 10, 2001

(30) Foreign Application Priority Data
Jul. 18, 2000 (IT) MI00A01631

(51) Int. Cl. B03C 1/00

(52) U.S. Cl. 210/748

(57) ABSTRACT

This invention describes a process and apparatus for the removal of heavy metals, particularly arsenic, from water. The process consists in promoting the circulation of the water to be treated in an electrolytic cell equipped with iron, or iron alloy, electrodes, while the contemporary insufflation into the cell of a gas, partially or totally composed of oxygen. In this way the iron of the anode electrodes dissolves as iron hydroxide. The ferrous hydroxide thus generated, under the action of the oxygen contained in the insufflated gas, is converted to ferric hydroxide, which, through a complex mechanism, adsorbs and forms insoluble complexes with the arsenic ions. By this process both forms of arsenic, As(lll) and As(V), are equally removed. The treated water is further processed by conventional clarifying and filtering processes.

### BACKGROUND OF INVENTION

This invention relates to a process and apparatus for the removal of heavy metals, particularly arsenic, from water. The presence of arsenic in natural waters is well known on different parts of the world, including Chile, China, Taiwan, Mexico, USA, some regions in Europe, and particularly severe in Bangladesh and West Bengal, north of India. The concentration levels may reach in some cases values up to 70 times the maximum permissible level of 50 μg/l (Bangladesh and Indian standard). It is argued that only in Bangladesh and West Bengal more than 30 Million people live at risk of severe illnesses, like skin, liver and bladder cancer, induced by arsenic contamination of drinking water. The removal of arsenic from water is based mainly on the following processes: Nanofiltration (including reverse osmosis), Electrodyalisis, Adsorption on solid surfaces , Adsorption with formation of insoluble complexes that can be removed by settling and filtration. Any pollutant removal process, therefore also arsenic remediation from water, has to face the main problem of the disposal of the by-products produced from said processes. Reverse Osmosis (RO) has a high removal efficiency but has the drawback that the primary water becomes highly polluted, with concentrations even higher than the water before treatment. Electrodyalisis presents nearly the same problems of the RO process, with higher costs. Adsorption on solid surfaces, like activated Alumina has a very good removal efficiency but at critical pH values. Therefore this process needs a strict pH monitoring and control. Moreover the spent Alumina presents disposal problems during its regeneration. The adsorption process with the formation of insoluble complexes that may be removed by settling and filtration is undoubtedly, from a practical point of view, the most convenient because of its reasonable costs and safety in sludge disposal. The processes of this type, currently employed, are based on the adsorption and/or coagulation followed by settling and filtration. This processes are based on the dissolution in water of iron or aluminium ions. In the case of iron (preferable to aluminium) the ferrous and ferric hydroxides combine chemically with metal ions (in this case arsenic) forming compounds like ferric arsenate and complexes of hydrous ferric oxide and arsenic acid. This compounds are water insoluble and can be easily removed by precipitation and filtration. The resulting sludge is stable and can be safely disposed, as usual, without any other successive treatment. In natural waters arsenic is usually found in two forms, as trivalent and pentavalent arsenic. The As(lll) is found mainly in ground water, and it is the most poisonous form. It is supposed to originate from the oxidation (contact with air) of arsenious rocks. The As(V) is found mainly in surface waters and is mainly the product of the oxidation of As(lll). Actually As(lll) can be easily oxidized to As(V) with, for example, chlorine, ozone or hydrogen peroxide. There are also some organic forms (Methylated Arsenicals), like Monomethylarsenate (MMA) or Dimethyilarsenate (DMA), found in surface waters due to herbicides contamination. The process for the removal of Arsenic from water at present currently employed consists of the following steps: i) addition of an oxidant (like chlorine) to convert As(lll) to As(V), ii) addition of a coagulant, for instance ferric chloride. At low concentrations and neutral pH ferric chloride hydrolyses to ferric hydroxide which absorbs arsenic ions, forming, as explained, Fe—As complexes. This complexes are insoluble forming flocks which precipitate, iii) the treated water is passed in a flocculator and clarifier and finally filtered, leaving it ready for use. This process needs the use of chemical products: oxidants for the oxidation of As(lll), acid and bases for pH control and possibly flocculant coadjutant and process control systems. The aforesaid process is the most popular because it has a good removal efficiency (more than 90%) and has the advantage of producing sludge that meet the test limits of TLCP (Toxicity Characteristic Leaching Procedure, EPA). There exists a bibliography regarding this process: Y. S. Shen, Study of Arsenic Removal from Drinking Water, JAWWA, August 1973, 543; John Gulledge and John T. O'Connor, Removal of Arsenic (V) from Water by Adsorption on Aluminium and Ferric Hydroxides, JAWWA, August 1973, 548. Another process, as described in the U.S. Pat. No. 5,368,703 uses Ferrous ions Fe(++) electrochemically generated in an electrolytic cell with bipolar electrodes of Iron (or alloy containing Iron). The anodic part of the electrodes dissolves as Ferrous (++) ions. The electrochemical reaction takes place directly into the water to be treated. The water that contains the Ferrous (++) ions is transferred into a reactor vessel where, after pH adjustment, it is added with Hydrogen Peroxide (H202). In this way As(lII) is oxidized to As(V) and the Ferrous Hydroxide is also oxidized to Ferric Hydroxide. This latter coagulates forming flocks in which As ions are adsorbed as complexes with the Ferric ions, this is similar to what happens with Ferric Chloride. The flocks are precipitated and filtered from the purified water.

### Summary of Invention

The principal aim of this invention is to find a process for the removal of heavy metals from water, and particularly Arsenic, with the help of iron hydroxides electrolytically generated but carried out in a more simplified way. In the context of this task one of the aims of this invention is to propose a process which does not need any chemical products nor pH adjustments. Another aim of this invention is to propose a process that, particularly in presence of Arsenic, is capable to remove very efficiently either trivalent As(lll) and pentavalent As(V). A further aim of this invention is to describe an apparatus capable to carry out the process as disclosed in the present invention. This apparatus should be of simple construction and reasonable cost. This task, together with other tasks which will be described further on, are performed by means of a process for the removal of heavy metals from water, particularly Arsenic. In this process the water is circulated in a electrolytic cell between a plurality of iron, or iron alloy, electrodes. In addition to this a gas containing oxygen, for example air, is insufflated trough or between the said iron electrodes. The water treated in this way is subsequently passed trough a flocculator and filter. The process, object of this invention, is preferably carried out with an apparatus apt to the removal from water of heavy metals, particularly Arsenic, which includes: an electrolytic cell with a plurality of iron, or iron alloy, electrodes and an intake connection for the water to be treated and an output connection for the treated water; means for circulating the water inside the electrolytic cell; means to insufflate the gas containing oxygen into the electrolytic cell. Further characteristics and advantages of the present invention will follow from the description of a preferred embodiment, but not the exclusive, of the process and apparatus objects of this invention.

### BRIEF DESCRIPTION OF DRAWINGS

FIG. 1 illustrates a schematic diagram of the apparatus for performing the process object of this invention;

FIG. 2 shows a longitudinal section of the electrolytic cell;

FIG. 3 shows a plan view of one of the elements of the electrolytic cell;

FIG. 4 shows a plan view of another element of the electrolytic cell;

FIG. 5 shows a plan view of a further element of the electrolytic cell.

With reference to the quoted figures the apparatus to carry out the process, object of this invention, is indicated with the number 1. It comprises an electrolytic cell (2), with a plurality of electrodes of iron, or iron alloy, or steel, having two hydraulic connections, one (3) for entering the water to be treated, and one (4) to extract the treated water. Moreover the apparatus comprises means for circulating the water inside the electrolytic cell (2), and means to insufflate a gas containing oxygen into the electrolytic cell (2).

### DETAILED DESCRIPTION

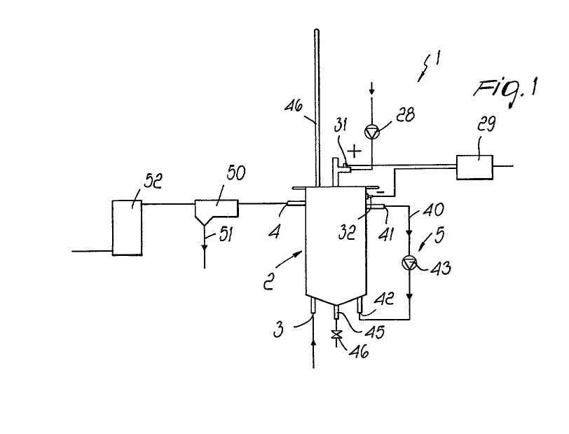

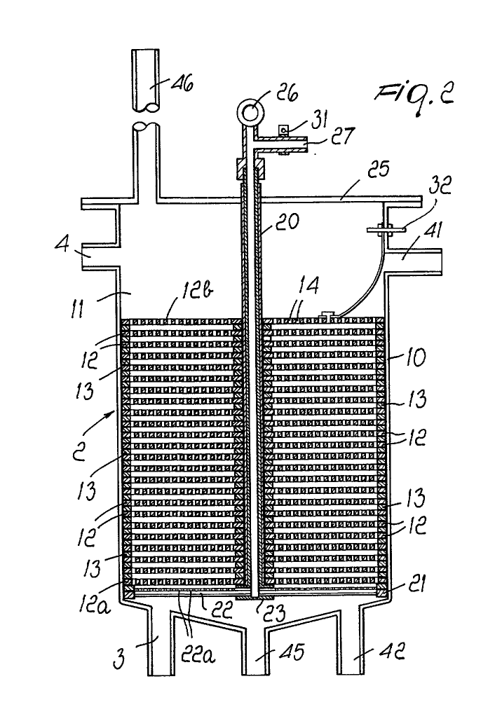

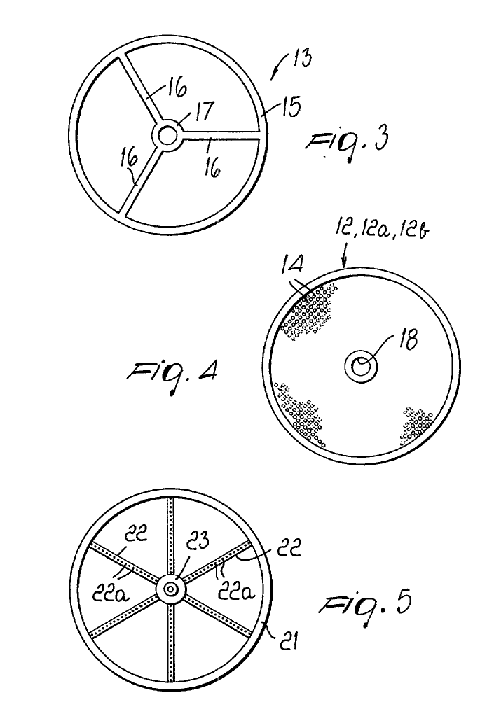

The electrolytic cell (2), as illustrated in detail in the FIG. 2, consists of a cylindrical housing (11) made with an electrical insulating material (PVC or glass fiber, etc)(10). It may be made also on metal (steel or stainless steel) but covered inside with an electrically insulating layer. The housing has its axis placed vertically. The inside of the cylindrical housing (11) is fitted with a stack of plates (12, 12a, 12b) composed of iron, iron alloy or steel. Said plates are stacked vertically along the axis of the cylindrical housing (11), separated from each other with spacers (13) made of electrically insulating material. As illustrated in detail in the FIG. 4 the plates (12, 12a, 12b) are made in the shape of discs perforated with a plurality of holes (14). Moreover each one of the mentioned plates has a central hole (18). As illustrated in detail in the FIG. 3 the spacers (13) are ring shaped and composed of an external ring (15) connected to a center ring shape element (17) by means of the spokes (16). The plates (12, 12a,12b), together with the spacers (13) are stacked one over the other and held in place by a tube (20) which passes through the holes (18) of the plates and spacers. The bottom end of the tube (20) is fitted with appropriate means through which the gas containing oxygen can be dispensed. More in detail the tube (20) is connected, on its bottom end, to a ring (21) which leans on the bottom of the housing (11). The ring (21), connected to the bottom part of the tube (20), is also connected to a plurality of tubes (22), radially protruding from ring (21), whose sides facing upwards are perforated with a plurality of small holes looking upwards. The bottom part of the tube (20) works as a cylindrical collector (23) and connects the inner part of the pierced pipes (22) with the inner part of the tube (20).-The tube (20) is made of metal covered on its outer surface with a layer of electrical insulating material in order to avoid an electrical contact between the stacked plate electrodes (12, 12a, 12b). The plate (12a) at the bottom of the plate stack is opportunely bolted to the ring collector (23) in order to form a good electrical contact between the plate (12a) and the vertical tube (20). The top part of the tube (20) protrudes from the housing (10) trough its cover (25), and ends with a ring (26) which is used to extract the whole stack of electrodes from the housing (10) in case of maintenance or substitution of the plates. The tube (20) is provided on its upper part with a connection (27) trough which the gas containing oxygen (preferably air) can be pumped with a pump (28, FIG. 1). Resuming, the tube (20) is used for three tasks: the first is to hold the entire stack of electrode plates; by means of the ring (26) it is possible to lift and extract the entire stack of plates out from the housing (10); the second is to distribute through the insufflator tubes (22) the air at the base of the electrode stack, the third is to form an electrical contact with the bottom plate of the stack. The electrode plate (12b) on top of the plate stack is electrically connected, trough the connection (32) to the other pole of the power supply (29). The power supply may consist, if connected to the a.c. power grid, of a rectifier and constant current regulator. it has to be noted that the rim of the electrode plates (12, 12a,12b) is covered by the insulating spacers in order to avoid the occurrence of by-pass unwanted current paths between bottom and top electrodes. The gas connection (27) and lift ring (26) form a single unit that can be removed from tube 20. This is necessary for removing the cover (25) of the housing (10) and for substituting the electrodes (12). Water circulation on the inside of the housing (10) can be accomplished by gravity or with a mechanical pump. Moreover it is necessary that the apparatus, in order to be capable to carry out the process object of This invention, includes recirculation of the water to be treated through the electrolytic cell (2). This recirculation circuit is composed by a conduit (40) connected to the outlet (41) of the housing (10). This outlet is placed at a level higher than the upper electrode plate (12b). The conduit (40) is connected, via a pump (43), to the bottom part (42) of the housing (10). In This way the treated water is pumped from outlet (41) to the inlet (42) and again, passing through the electrode stack (12 . . . ), to the outlet (41). On the bottom of the housing (10) there is a drain connection (45) controlled by the valve (46). This drain is necessary to empty the housing (10) from possible scale deposits or other solid waste. The top cover of the housing is connected to a vent pipe (46) for flushing the hydrogen gas formed during the electrolysis, and the excess gas containing oxygen (air) which is insufflated into the housing (10) trough the inlet connection (27). The whole apparatus is completed by a clarifier (50), where the iron hydroxide sludge is separated from the treated water and collected through the discharge conduit (51), and by a finishing filter (52). The two, clarifier (50) and filter (52) are of conventional and well known design. The operation of the apparatus for the process of this invention is the following: The water to be treated, at a temperature preferably comprised between 20 and 25° Centigrade, is introduced into the housing (11) throng the inlet connection (3). By means of the power supply (29) a d.c. voltage is applied between the first electrode plate (12a) at the bottom of the stack and the last electrode plate (12b) on top of the stack. In this way an electric current flows through the entire electrolytic cell. This is due to the fact that water contains always some ions dissolved giving rise to an electric conductivity, expressed in 1/(ohms.cm), or Siemens/cm. The dissolved ions concentration is normally quite low (ranging from a few tens up to a 1000 mg/l). For simplicity we will not consider this dissolved ions except the OH⁻ and H⁺ ions. Every plate of the stack, except the two extreme plates (12a) and (12b), operate as a bipolar electrode, as the two faces of each plate operate one as anode and the other as cathode. On the anode side Ferrous Hydroxide is formed according to the reaction 2OH⁻+Fe−2e=>Fe(OH)₂ at the cathode side Hydrogen gas is evolved. Ferrous Hydroxide is partially dissociated to Ferrous ion Fe⁺⁺ and hydroxide ion 2(OH)⁻. The Faradic efficiency is practically very nearly one.

The water during treatment is recirculated several times by the pump (43) inside the electrolytic cell (2) in order to increase the contact time with the electrodes (12, 12a, 12b). For this purpose, if necessary, it is possible to interpose a tank in the recirculation line (40). Inside the cell (2), at its bottom, during the dissolution of the steel (or iron, or iron alloy) anodes, air (or a gas containing oxygen) is insufflated by means of the gas diffuser tubes (22). Also air (or equivalent gas) is recirculated several times trough the cell (2). The role of the oxygen contained in the gas is fundamental because it causes the oxidation of Fe(ll) to Fe(III), the last forming the ferric hydroxide, highly insoluble and the main responsible for Arsenic removal. It should be pointed out that with the process of this invention, the removal efficiency of As(lll) is the same as for As(V): no previous oxidation is necessary to convert As(lll) to As(V). This is opposed to the knowledge to date. This is probably due to an oxidation mechanism of As(lll) due to the combined action of the oxygen contained in the insufflated gas and a possible anodic oxidation. The ferric hydroxide thus formed absorbs the arsenic ions forming stable and insoluble complexes, which forms flocks that may easily precipitate. Therefore from outlet (4) one has a flow of water mixed with a mass of coagulated flocks of iron hydroxides. In the clarifier (50) the flocks precipitate and are concentrated and finally extracted as a sludge. The clarified water is successively filtered by means of conventional filters such as sand filters or filterpress or membrane. The energy needed to power the process and the apparatus of this invention is relatively low, as will be shown in the example described below. The current density on the electrode plates may vary from a few mA/sqcm to a few tens mA/sqcm. Therefore, knowing that the Faradic efficiency is practically one, the amount of bivalent iron, Fe⁺⁺, produced (or equivalently, dissolved) is approximately 1 mg for every mA.hour of current delivered to the cell. As an example, considering a voltage of 7 Volts applied between anode and cathode, the energy necessary to produce (or dissolve) 1 gr of iron is 7 Watt.hour. To remove arsenic to 99.5% the Fe/As ratio (resulting from laboratory tests) must range from 10 to 15. Therefore considering an amount of 100 lt of water with an arsenic concentration of 1 mg/lt, to remove it down to 5 μg/lt one needs 1.5 gr of dissolved iron which is equivalent to an energy consumption of 10.5 W.h. For 10,000 lt the energy needed is 1.05 kW.h. Obviously this energy is needed only for the electrolytic cell to which must be added the energy for the pumps, control circuitry, conversion losses, etc. The cell (2) operates at constant current (d.c.), therefore to change the quantity of dissolved iron (iron hydroxides produced) it is necessary to change only the current through the cell. In order to avoid deposits of alkaline hydroxides (scale) on the cathodes the power supply automatically inverts the polarity of the current delivered to the cell at regular intervals. In this way scale is detached from the electrodes and can be collected on the bottom of the housing (10) and drained from the outlet (45) and (46). At regular time intervals the plates (12, 12a,12b) may be substituted with new ones because of consumption of the anodic sides (iron dissolves as Ferrous hydroxide during electrolysis). This can be easily carried out by extracting the whole stack of electrodes. The sludge extracted from the clarifier (50) and from the filter (52) are stable and satisfy the test TLCP of the EPA (USA), therefore they may be disposed, without any additional treatment, into appropriate dumps. It has been verified that the process and apparatus of this invention fully satisfies the proposed task: in one single stage consisting of an electrolytic cell with water recirculation and insufflation of air (or a gas containing oxygen) it is possible to remove both kind of arsenic, trivalent and pentavalent, without the need of any additional chemical product, nor adjustment of the pH, provided the pH of the water to be treated is in the range from 6 to 8. As a possible application of this invention a numerical example is described here below.

Application example It is assumed to have a water to be treated with a total arsenic concentration of 1 mg/lt and a flow rate of 10,000 lt/h. Working with a Fe/As ratio of 15 (to have a 99.5% arsenic removal) one needs 15 mg of Fe(ll) for every liter of water, which makes a total of 150 gr/h of Fe(ll). Knowing that one needs 1 Amp.hour for every gram of iron dissolved in the electrolytic cell, in total we need 150 Amp.hour. On this data it is possible to design the electrolytic cell: Housing capacity: 500 lt (height: 1500 mm.), diameter of the electrode plates (=inner diameter of the cell): 600 mm., plate thickness: 6- 7 mm., gap between plates: 4 mm., number of plates: 17, current density: 4 mA/sqcm., supply voltage: 170 V. d.c., and current: 9.2 Amp. d.c., resulting in a power delivery of 1.56 kW. With a water recirculation flow of 15,000 lt/h, the retention (contact) time is approx. 6.7 min. The air flow, calculated from the quantity of Fe(ll) to be oxidized to Fe(lll), is about 100 lt/h, referred to a normal pressure and temperate of 20-25° C. The process and apparatus as described can be modified and/or changed in many ways, provided they are part of the ground concept of this invention. Moreover all the technical details can be substituted with other equivalent elements. In the practice all the components and their dimensions employed for the realization of this process and apparatus, provided they are compatible to their specific tasks, can be modified according to the necessities and the technical progress. Although the process and apparatus of this invention has been developed for the removal of arsenic from water, it can anyhow be employed for the removal of other metals from water like mercury, chromium, cadmium, etc. Moreover, although the process and apparatus of this invention has been conceived particularly for the treatment of drinking water, it can be employed also for the treatment of industrial or agricultural wastewaters.

1. Process for the removal of heavy metals, particularly arsenic, from water, comprising the step of circulating the water to be treated through an electrolytic cell composed of a plurality of electrodes made of iron, or iron alloy, or steel, through which a gas containing oxygen, is insufflated. The water after treatment is clarified and filtered.

2. Process according to claim 1 wherein the water to be treated is continuously recirculated many times through said electrolytic cell.

3. Process according to claims 1 and 2 wherein the water recirculated through said cell passes through a temporary storage tank in order to increase the time of permanence in said electrolytic cell.

4. Process according to one or more of the preceding claims wherein said gas containing oxygen is air.

5. Apparatus for the removal of heavy metals, particularly arsenic, from water, comprising: An electrolytic cell having a plurality of electrodes made of iron, or iron alloy, or steel, said cell having an inlet connector for the water to be treated and an outlet connector for the treated water; means for circulating the water through said electrolytic cell; means for insufflating a gas containing oxygen into said electrolytic cell.

6. Apparatus according to one or more of the preceding claims wherein it includes means for the settling and filtration of the water flowing out from said cell.

7. Apparatus according to one or more of the preceding claims wherein said electrolytic cell is composed by a cylindrical housing, vertically positioned, lined inside with a layer of insulating material. Internally to said housing a plurality of circular plates made of iron, or steel, or iron alloy are stacked along the axis of said housing. Said plates are spaced by means of electrically insulating spacers. The first and last plates, on top and bottom of the stack, are electrically connected to two terminals that are connected to an electrical power supply which delivers a constant d.c. current to the electrode stack. Said means for insufflating the said gas are fitted on the bottom of said housing and placed under the first bottom electrode plate. The said water inlet and outlet are placed respectively under and on top of the electrode plate stack.

8. Apparatus according to one or more of the preceding claims wherein each one of said plates is in contact at its rim with the inner wall of said housing. Each plate are pierced with a plurality of holes.

9. Apparatus according to one or more of the preceding claims wherein said plates are stacked coaxially to a tube that holds the whole stack. At the bottom end of said tube are fitted said means for the insufflation of the gas containing oxygen. The upper end of said tube extends from the top cover of said housing and is fitted with a connection for the supply of said gas.

10. Apparatus according to one or more of the preceding claims wherein the means for the insufflation of said gas include a center collector connected to the bottom end of said central tube and a plurality of radial tubular branches extending from the said center collector. Said branches have holes pierced along their upper part for the delivery of said gas.

11. Apparatus according to one or more of the preceding claims wherein said housing is equipped on its top cover with a gas exhaust pipe, said gases being generated inside said housing.

12. Apparatus according to one or more of the preceding claims wherein it is equipped with means for the water recirculation through said electrolytic cell.

13. Apparatus according to one or more of the preceding claims wherein the water recirculation circuit includes an input pipe in communication with the upper part of said electrodes stack, and an output pipe in communication with the space under said electrodes stack. A pump is installed between the input and output pipes.

14. Apparatus according to one or more of the preceding claims wherein in said recirculation circuit a tank is inserted as a temporary storage of the recirculated water

15. Apparatus according to one or more of the preceding claims wherein the electrode stack can be extracted from the housing of said electrolytic cell.

16. Process and apparatus for the removal from water of heavy metals, particularly arsenic, as described and illustrated above.
